(19) United States
(12) Patent Application Publication
(10) Pub. No.: US 2007/0003587 A1
(43) Pub. Date: Jan. 4, 2007

(54) Granular pesticidal formulation

(75) Inventors: Osamu Hoshina, Toyonaka-shi (JP); Seiji Iuchi, Takarazuka-shi (JP); Yoshihiro Takebayashi, Toyonaka-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/447,128

(22) Filed: Jun. 6, 2006

(30) Foreign Application Priority Data
Jun. 30, 2005 (JP) 2005-191180

(51) Int. Cl. A01N 25/08

(52) U.S. Cl. 424/410

(57) ABSTRACT

A granular pesticidal formulation which comprise (A) 16-40% by weight of a liquid pesticidal component, (B) 30-70% by weight of at least one saccharide, (C) 8-20% by weight of silica, (D) 0.5-6% by weight of bentonite and (E) 5-20% by weight of at least one surfactant, wherein the total weight of the component (C) and the component (D) is 0.9 to 0.4 times of the weight of the component (A) and the weight of the component (D) is 0.6 to 0.05 times of the weight of the component (C) provides a good stability of the aqueous dilution and the application of the dilution causes few stains on the crop surface.

### TECHNICAL FIELD

The present invention relates to a granular pesticidal formulation.

### BACKGROUND ARTS

In pesticidal formulations, water dispersible granules are in great demand for easy use, safety and compactness in transportation. Water dispersible granules are usually diluted 10-10000 times with water and the dilution is applied to crops. In the use of insecticides or fungicides to vegetables or fruits, it often get into trouble that solid carriers existing much in the water dispersible granules remain on the surface of the crops and make the appearance of the crops damaged.

To solve the problem, JP2003-95809A suggests the use of a saccharide for a main component of the carrier in water dispersible granules. However, when the pesticidal component in the water dispersible granules is liquid, the water dispersible granules described in JP2003-95809A do not necessarily provide a sufficient stability of the formulation.

### SUMMARY OF THE INVENTION

The invention directs to a granular pesticidal formulation, which can be used as water dispersible granules, wherein the pesticidal component is liquid. The present invention provides a granular pesticidal formulation which comprise (A) 16-40% by weight of a liquid pesticidal component, (B) 30-70% by weight of at least one saccharide, (C) 8-20% by weight of silica, (D) 0.5-6% by weight of bentonite and (E) 5-20% by weight of at least one surfactant, wherein the total weight of the component (C) and the component (D) is 0.9 to 0.4 times of the weight of the component (A) and the weight of the component (D) is 0.6 to 0.05 times of the weight of the component (C).

According to the present invention, the granular pesticidal formulation provides a good stability of the aqueous dilution and the application of the dilution causes few stains on the crop surface.

### DETAILED DESCRIPTION OF THE INVENTION

The liquid pesticidal component (A) can be a liquid pesticidally active compound itself or a solution of an organic solvent containing a pesticidally active compound. In the latter case, the pesticidally active compound may be solid or liquid. In the present invention, when the pesticidally active compound is solid, it is dissolved with an organic solvent and the solution is provided as the liquid pesticidal component (A). Further, the liquid pesticidal component (A) can be a mixture of two or more pesticidally active compounds as long as the mixture is liquid at ordinary temperature, namely 20° C., or a solution containing two or more pesticidally active compounds.

The pesticidally active compounds can be insecticidal compounds, acaricidal compounds, fungicidal compounds, herbicidal compounds, plant growth regulating compounds, insect growth regulating compounds and the like, preferably insecticidal compounds, acaricidal compounds and fungicidal compounds. Examples of the pesticidally active compound include organophosphorus compounds such as O,O-dimethyl O-(3-methyl-4-nitrophenyl)phosphorothioate, O,O-dimethyl O-{3-methyl-4-(methylthio)phenyl}phosphorothioate, O,O-diethyl O-2-isopropyl-6-methylpyrimidin-4-yl phosphorothioate, O,O-diethyl O-3,5,6-trichloro-2-pyridyl phosphorothioate, O,S-dimethyl acetylphosphoramidothioate, S-2,3-dihydro-5-methoxy-2-oxo-1,3,4-thiadiazol-3-ylmethyl O,O-dimethyl phosphorodithioate, O,O-diethyl S-2-ethylthioethyl phosphorodithioate, 2,2-dichlorovinyl dimethyl phosphate, O-ethyl O-4-(methylthio)phenyl S-propyl phosphorodithioate, O-4-cyanophenyl O,O-dimethyl phosphorothioate, 2-methoxy-4H-1,3,2-benzodioxaphosphorin-2-sulfide, O,O-dimethyl S-(N-methylcarbamoylmethyl)dithiophosphate, ethyl 2-dimethoxyphosphinothioylthio(phenyl)acetate, diethyl(dimethoxyphosphinothioylthio)succinate, dimethyl 2,2,2-trichloro-1-hydroxyethylphosphonate, S-3,4-dihydro-4-oxo-1,2,3-benzotriazin-3-ylmethyl O,O-dimethyl phosphorodithioate, dimethyl{(E)-1-methyl-2-(methylcarbamoyl)vinyl}phosphate, O,O,O′,O′-tetraetyl S,S′-methylene bis(phosphorodithioate) and O-2,6-dichloro-4-methylphenyl O,O-dimethyl phosphorothioate; carbamate compounds such as 2-sec-butylphenyl methylcarbamate, ethyl N-{2,3-dihydro-2,2-dimethylbenzofuran-7-yloxycarbonyl(methyl)aminothio}-N-isopropyl-β-alaninate, 2-isopropoxyphenyl N-methylcarbamate, 2,3-dihydro-2,2-dimethyl-7-benzo[b]furanyl N-dibutylaminothio-N-methylcarbamate, 1-naphthyl N-methylcarbamate, S-methyl-N-(methylcarbamoyloxy)thioacetimidate, 2-(ethylthiomethyl) phenylmethylcarbamate, 2-methyl-2-(methylthio) propionaldehyde O-methylcarbamoyloxime, N,N-dimethyl-2-methylcarbamoyloxyimino-2-(methylthio)acetamide and S-4-phenoxybutyl N,N-dimethylthiocarbamate; pyrethroid compounds such as 2-(4-ethoxyphenyl)-2-methyl-1-(3-phenoxybenzyl)oxypropane, (RS)-α-cyano-3-phenoxybenzyl (RS)-2-(4-chlorophenyl)-3-methylbutyrate, (S)-α-cyano-3-phenoxybenzyl (S)-2-(4-chlorophenyl)-3-methylbutyrate, (RS)-α-cyano-3-phenoxybenzyl 2,2,3,3-tetramethylcyclopropanecarboxylate, (RS)-α-cyano-3-phenoxybenzyl (1RS)-cis, trans-3-(2,2-dichlorovinyl)-2,2-dimethylcyclopropanecarboxylate, 3-phenoxybenzyl (1RS)-cis,trans-3-(2,2-dichlorovinyl)-2,2-dimethylcyclopropanecarboxylate, (RS)-α-cyano-3-phenoxybenzyl (1RS,3Z)-cis-3-(2-chloro-3,3,3-trifluoroprop-1-enyl)-2,2-dimethylcyclopropanecarboxylate, (S)-α-cyano-3-phenoxybenzyl (1R)-cis-3-(2,2-dibromovinyl)-2,2-dimethylcyclopropanecarboxylate, (RS)-α-cyano-3-phenoxybenzyl (RS)-2,2-dichloro-1-(4-ethoxyphenyl)cyclopropanecarboxylate, α-cyano-3-phenoxybenzyl N-(2-chloro-α,α,α-trifluoro-p-tolyl)-D-valinate, 2-methyl-3-phenylbenzyl (1RS,3Z)-cis-3-(2-chloro-3,3,3-trifluoro-1-propenyl)-2,2-dimethylcyclopropanecarboxylate, 2-(4-bromodifluoromethoxyphenyl)-2-methyl-1-(3-phenoxybenzyl)methylpropane, (S)-α-cyano-3-phenoxybenzyl (1R)-cis-3-(1,2,2,2-tetrabromoethyl)-2,2-dimethylcyclopropanecarboxylate, (4-ethoxyphenyl)-{3-(4-fluoro-3-phenoxyphenyl)propyl}dimethylsilane, 3-phenoxybenzyl (1R)-cis,trans-2,2-dimethyl-3-(2-methyl-1-propenyl) cyclopropanecarboxylate, (RS)-α-cyano-3-phenoxybenzyl (1R)-cis,trans-2,2-dimethyl-3-(2-methyl-1-propenyl)cyclopropanecarboxylate, 5-benzyl-3-furylmethyl (1R)-cis,trans-2,2-dimethyl-3-(2-methyl-1-propenyl) cyclopropanecarboxylate, (S)-α-cyano-3-phenoxybenzyl (1R,3Z)-cis-(2,2-dimethyl-3-{3-oxo-3-(1, 1,1,3,3,3-hexafluoropropyloxy)propenyl}cyclopropanecarboxylate, (RS)-α-cyano-4-fluoro-3-phenoxybenzyl 3-(2,2-dichlorovinyl)-2,2-dimethylcyclopropanecarboxylate, 2,3,5,6-tetrafluoro-4-methylbenzyl (1RS,3Z)-cis-3-(2-chloro-3,3,3-trifluoro-1-propenyl)-2,2-dimethylcyclopropanecarboxylate, 2,3,5,6-tetrafluorobenzyl (1R)-trans-3-(2,2-dichlorovinyl)-2,2-dimethylcyclopropanecarboxylate, 3,4,5,6-tetrahydrophthalimidomethyl (1RS)-cis,trans-2,2-dimethyl-3-(2-methyl-1-propenyl)cyclopropanecarboxylate, (RS)-2-methyl-4-oxo-3-(2-propenyl)-2-cyclopenten-1-yl (1RS)-cis,trans-2,2-dimethyl-3-(2-methyl-1-propenyl) cyclopropanecarboxylate, (S)-2-methyl-4-oxo-3-(2-propynyl)-2-cyclopenten-1-yl (1R)-cis,trans-2,2-dimethyl-3-(2-methyl-1-propenyl)cyclopropanecarboxylate, (RS)-1-ethynyl-2-methyl-2-pentenyl (1R)-cis,trans-2,2-dimethyl-3-(2-methyl-1-propenyl)cyclopropanecarboxylate, 2,5-dioxo-3-(2-propynyl)imidazolidin-1-ylmethyl (1R)-cis,trans-2,2-dimethyl-3-(2-methyl-1-propenyl) cyclopropanecarboxylate, 5-(2-propynyl)furfuryl (1R)-cis,trans-2,2-dimethyl-3-(2-methyl-1-propenyl)cyclopropanecarboxylate, 5-(2-propynyl)furfuryl 2,2,3,3-tetramethylcyclopropanecarboxylate, (RS)-3-allyl-2-methyl-4-oxocyclopent-2-enyl (1RS,3RS;1RS,3SR)-2,2-dimethyl-3-(2-methylprop-1-enyl) cyclopropanecarboxylate; phosphorylated amino acid compounds such as N-phosphonomethylglicine and pesticidally acceptable salts thereof and 4-hydroxymethylphosphinoyl-L-homoalanyl-L-alanine; thiadiadine derivatives such as 3-isopropyl-1H-2,1,3-benzothiazin-4(3H)-one-2,2-oxide and 2-tert-butylimino-3-isopropyl-5-phenyl-1,3,5-thiadiazin-4-one; nitroguanidine derivatives such as (E)-1-(2-chloro-1,3-thiadiazol-5-ylmethyl)-3-methyl-2-nitroguanidine, (EZ)-(RS)-1-methyl-2-nitro-3-(tetrahydro-3-furylmethyl) guanidine and (EZ)-3-(2-chloro-1,3-thiazol-5-ylmethyl)-5-methyl-1,3,5-oxadiadinam-4-ylidene(nitro)amine; pyridylmethylamine derivatives such as (E)-N¹-[(6-chloro-3-pyridyl)methyl]-N²-cyano-N¹-methylacetamidine and (E)-N-(6-chloro-3-pyridylmethyl)-N-ethyl-N′-methyl-2-nitrovinylidenediamine; N-cyanoamidine derivatives such as N-cyano-N′-methyl-N′-(6-chloro-3-pyridylmethyl)acetamidine; nereistoxin derivatives such as S,S′-(2-dimethylaminotrimethylene)bis(thiocarbamate), N,N-dimethyl-1,2,3-trithian-5-ylamine and S,S′-2-dimethylaminotrimethylenedi(benzenethiosulfonate); chlorinated hydrocarbon compounds such as 6,7,8,9,10,10-hexachloro-1,5,5a,6,9,9a-hexahydro-6,9-methano-2,4,3-benzodioxathiepineoxide, 1,2,3,4,5,6-hexachlorocyclohexane and 1,1-bis(4-chlorophenyl)-2,2,2-trichloroethanol; benzoylphenylurea compounds such as 1-{3,5-dichloro-4-(3-chloro-5-trifluoromethylpyridin-2-yloxy)phenyl}-3-(2,6-difluorobenzoyl)urea, 1-(3,5-dichloro-2,4-difluorophenyl)-3-(2,6-difluorobenzoyl)urea and 1-{4-(2-chloro-4-trifluoromethylphenoxy)-2-fluorophenyl}-3-(2,6-difluorobenzoyl)urea; formamidine derivatives such as N,N′-{(methylimino)dimethylidine}-di-2,4-xylidine and N′-(4-chloro-2-methylphenyl)-N,N-dimethylmethynimidamide; thiourea derivatives such as N-(2,6-diisopropyl-4-phenoxyphenyl)-N′-t-butylcarbodiimide; N-phenylpyrazole compounds; 5-methoxy-3-(2-methoxyphenyl)-1,3,4-oxadiazol-2(3H)-one, isopropyl 4,4′-dibromobenzylate, 4-chlorophenyl 2,4,5-trichlorophenyl sulfone, S,S-6-methylquinoxaline-2,3-diyl dithiocarbonate, 2-(4-tert-butylphenoxy)cyclohexylprop-2-yl sulfite, bis{tris(2-methyl-2-phenylpropyl)tin}oxide, (4RS,5RS)-5-(4-chlorophenyl)-N-chlorohexyl-4-methyl-2-oxo-1,3-thiazolidine-3-carboxamide, 3,6-bis(2-chlorophenyl)-1,2,4,5-tetrazine, 2-tert-butyl-5-(4-tert-butylbenzylthio)-4-chloropyridazin-3(2H)-one, tert-butyl (E)-4-[(1,3-dimethyl-5-phenoxypyrazol-4-yl) methyleneaminooxymethyl]benzoate, N-4-tert-butylbenzyl-4-chloro-3-ethyl-1-methyl-5-pyrazolecarboxamide, tetranactin, dinactin, trinactin, 5-chloro-N-[2-{4-(2-ethoxyethyl)-2,3-dimethylphenoxy}ethyl]-6-ethylpyrimidine-4-amine, milbemectin, avermectin, ivermectin, azadirachtin [AZAD], 5-methyl [1,2,4]triazolo[3,4-b]benzothiazole, methyl 1-(butylcarbamoyl)benzimidazole-2-carbamate, 6-(3,5-dichloro-4-methylphenyl)-3(2H)-pyridazinone, 1-(4-chlorophenoxy)-3,3-dimethyl-1-(1H-1,2,4-triazol-1-yl)butanone, (E)-4-chloro-2-(trifluoromethyl)-N-[1-(imidazol-1-yl)-2-propoxyethylidene]aniline, 1-[N-propyl-N-[2-(2,4,6-trichlorophenoxy)ethyl]carbamoyl]imidazol, (E)-1-(4-chlorophenyl)-4,4-dimethyl-2-(1H-1,2,4-triazol-1-yl)-1-penten-3-ol, 1-(4-chlorophenyl)-4,4-dimethyl-2-(1H-1,2,4-triazol-1-yl)-1-pentan-3-ol, (E)-1-(2,4-dichlorophenyl)-4,4-dimethyl-2-(1H-1,2,4-triazol-1-yl)-1-penten-3-ol, 1-(2,4-dichlorophenyl)-4,4-dimethyl-2-(1H-1,2,4-triazol-1-yl)-1-pentan-3-ol, 4-[3-(4-tert-butylphenyl)-2-methylpropyl]-2,6-dimethylmorpholine, 2-(2,4-dichlorophenyl)-1-(1H-1,2,4-triazol-1-yl)hexan-2-ol, O,O-diethyl O-2-quinoxalinyl phosphorothioate, O-(6-ethoxy-2-ethyl-4-pyrimidinyl) O,O-dimethyl phosphorothioate, 2-diethylamino-5,6-dimethylpyrimidin-4-yl dimethylcarbamate, 4-(2,4-dichlorobenzoyl)-1,3-dimethyl-5-pyrazolyl p-toluenesulfonate, 4-amino-6-(1,1-dimethylethyl)-3-methylthio-1,2,4-triazin-5(4H)-one, 2-chloro-N-[(4-methoxy-6-methyl-1,3,5-triazin-2-yl)aminocarbonyl]benzenesulfonamide, 2-methoxycarbonyl-N-[(4,6-dimethoxypyrimidin-2-yl)aminocarbonyl]benzenesulfonamide, 2-methoxycarbonyl-N-[(4,6-dimethylpyrimidin-2-yl)aminocarbonyl]benzenesulfonamide, 2-methoxycarbonyl-N-[(4-methoxy-6-methyl-1,3,5-triazin-2-yl)aminocarbonyl]benzenesulfonamide, 2-ethoxycarbonyl-N-[(4-chloro-6-methoxypyrimidin-2-yl)aminocarbonyl]benzenesulfonamide, 2-(2-chloroethoxy)-N-[(4-methoxy-6-methyl-1,3,5-triazin-2-yl)aminocarbonyl]benzenesulfonamide, 2-methoxycarbonyl-N-[(4,6-dimethoxypyrimidin-2-yl)aminocarbonyl]phenylmethanesulfonamide, 2-methoxycarbonyl-N-[(4-methoxy-6-methyl-1,3,5-triazin-2-yl)aminocarbonyl]thiophene-3-sulfonamide, 4-ethoxycarbonyl-N-[(4,6-dimethoxypyrimidin-2-yl)aminocarbonyl]-1-methylpyrazole-5-sulfonamide, 2-[4,5-dihydro-4-methyl-4-(1-methylethyl)-5-oxo-1H-imidazol-2-yl]-3-quinolinecarboxylic acid, 5-ethyl-5,8-dihydro-8-oxo[1,3]dioxolo[4,5-g]quinoline-7-carboxylic acid, 2-[4,5-dihydro-4-methyl-4-(1-methylethyl)-5-oxo-1H-imidazol-2-yl]-5-ethyl-3-pyridinecarboxylic acid, methyl 6-(4-isopropyl-4-methyl-5-oxoimidazolin-2-yl)-m-toluate, methyl 2-(4-isopropyl-4-methyl-5-oxoimidazolin-2-yl)-p-toluate, 2-(4-isopropyl-4-methyl-5-oxoimidazolin-2-yl)nicotinic acid, N-(4-chlorophenyl)methyl-N-cyclopentyl-N′-phenylurea, (RS)-2-cyano-N-[(R)-1-(2,4-dichlorophenyl)ethyl]-3,3-dimethylbutyramide, N-(1,3-dihydro-1,1,3-trimethylisobenzofuran-4-yl)-5-chloro-1,3-dimethylpyrazole-4-carboxamide, N-[2,6-dibromo-4-(trifluoromethoxy)phenyl]-2-methyl-4-(trifluoromethyl)-5-thiazolcarboxamide, 2,2-dichloro-N-[1-(4-chlorophenyl)ethyl]-3-methylcyclopropanecarboxamide, methyl (E)-2-{2-[6-(2-cyanophenoxy) pyrimidin-4-yloxy]phenyl}-3-methoxyacrylate, 5-methyl-1,2,4-triazolo[3,4-b]benzothiazole, 3-allyloxy-1,2-benzoisothiazol-1,1-dioxide, diisopropyl 1,3-dithiolan-2-ylidenemalonate and O,O-dipropyl O-4-methylthiophenyl phosphate.

Preferable pesticidally active compounds for the present granular pesticidal formulation are pyrethroid compounds and organophosphorus compounds, and typical preferable examples include (S)-α-cyano-3-phenoxybenzyl (S)-2-(4-chlorophenyl)-3-methylbutyrate, 3-phenoxybenzyl (1RS)-cis,trans-3-(2,2-dichlorovinyl)-2,2-dimethylcyclopropanecarboxylate, (RS)-α-cyano-3-phenoxybenzyl (1RS)-cis,trans-3-(2,2-dichlorovinyl)-2,2-dimethylcyclopropanecarboxylate, (RS)-α-cyano-3-phenoxybenzyl 2,2,3,3-tetramethylcyclopropanecarboxylate, O,O-dimethyl O-(3-methyl-4-nitrophenyl) phosphorothioate, O-4-cyanophenyl O,O-dimethyl phosphorothioate, diethyl (dimethoxythiophosphorylthio)succinate and S-α-ethoxycarbonylbenzyl O,O-dimethyl phosphorodithioate.

The organic solvent is an organic solvent or a mixture of two or more organic solvents which can dissolve the pesticidally active compound to give a homogeneous solution. Examples of the organic solvent include paraffins such as normal paraffin, isoparaffin and cycloparaffin; aromatic hydrocarbons such as xylene, alkylbenzene, alkylnaphthalene, phenylxylylethane and diphenylxylylethane; ketones such as cyclohexanone, heptanone, octanone, nonanone and acetophenone; esters such as hexyl acetate, benzyl acetate, phenylethyl acetate, benzyl benzoate, methyl benzoate, isobutyl oleate, benzyl salicilate, butylcyclohexyl acetate, methylbenzyl acetate, methyl oleate, methyl laurate, isononyl isononate and octyl palmitate; alcohols such as ethylene glycol, propylene glycol, benzyl alcohol and phenylethyl alcohol; and vegetable oils such as rapeseed oil, soybean oil, linseed oil, olive oil and rice-bran oil. Preferred are aromatic hydrocarbons and more preferred are alkylbenzene and phenylxylylethane.

When the liquid pesticidal component (A) is a solution of an organic solvent containing one or more pesticidally active compounds, the weight ratio of the organic solvent to the pesticidally active compound or compounds is usually within the range between 0.5 to 1 and 3 to 1.

The amount of the liquid pesticidal component (A) is 16-40% by weight in the present granular pesticidal formulation.

The preferred embodiment of the present granular pesticidal formulation comprises a liquid pesticidal component (A) consisting of a pyrethroid compound and an organic solvent, wherein the amount of the pyrethroid compound is 5-15% by weight and the amount of the organic solvent is 5-25% by weight in the present granular pesticidal formulation.

Examples of the saccharide (B) include monosaccharide and oligosaccharide such as glucose, fructose, sucrose, lactose and maltose; and soluble modified starch such as sorbitol, maltitol, reduced lactose, dextrin, soluble starch and oxidized starch. Preferable are monosaccharide and oligosaccharide, more preferable are lactose and sucrose.

The amount of the saccharide (B) is 30-70% by weight in the present granular pesticidal formulation.

The silica (C) in the present granular pesticidal formulation is silicon dioxide, SiO₂. Examples of the silica include crystallized silica such as quartz, which has a certain crystal structure and exists in nature, and amorphous silica, which does not have any crystal structure, such as hydrated silica, precipitated silica, synthetic silica and dry silica. Amorphous silica is preferably used. Among them, precipitated silica is more preferable and calcined product of precipitated silica is the most preferable. The calcined product of precipitated silica is prepared by calcining the precipitated silica at 700-900° C., preferably 800-900° C.

Precipitated silica is also called synthetic hydrated silica, and it is available on the market. Preferable examples of the precipitated silica on the market include Tokusil (manufactured by Tokuyama), Carplex (manufactured by Degussa Japan), Nipsil (manufactured by Nihon Silica), Ultransil (manufactured by Degussa) and SIPERNAT 50S (manufactured by Degussa Japan). In the present invention, a mixture of plural kinds of silica can be used for the component (C).

Further, in the present invention, the particle diameter of the silica is preferably 10 μm or less (volume median diameter) and the oil absorption of the silica is preferably 200 ml/100 g or more of the value measured by JIS K5101.

The amount of the silica (C) is 8-20% by weight in the present granular pesticidal formulation. When the amount of the silica is more than 20% by weight, the application of the aqueous dilution of the present granular pesticidal formulation to the crop tends to cause stains on the crop surface, which may decrease the value of the crops such as vegetables and fruits very much.

The bentonite (D) in the present granular pesticidal formulation is a material known as a water-swelling mineral carrier, and it is clay mainly composed of montmorillonite. Examples of the available bentonite include sodium bentonite and calcium bentonite. Sodium bentonite is preferably used for the present invention.

In the present invention, bentonite having 20 ml/2 g or more of swelling ability is preferably used for the component (D). More preferable is the bentonite having 50 ml/2 g or more of swelling ability. Throughout this description, the swelling ability means the value defined in JBAS-104-77 of Japan Bentonite Manufacturers Association Standard.

Preferable examples of the bentonite used for the present invention include Kunipia G and Kunipia F (produced by Kunimine Industries) and Superclay (produced by Hojun). In the present invention, a mixture of plural kinds of bentonite can be used for the component (D).

The amount of the bentonite (D) is 0.5-6% by weight in the present granular pesticidal formulation. Further, the total weight of the silica (C) and the bentonite (D) is 0.9 to 0.4 times of the weight of the liquid pesticidal component (A). When the total amount of the silica and bentonite is over 0.9, the stains on the crop surface may be impermissible in some crops after the application of the aqueous dilution of the present granular pesticidal formulation to the crop. On the other hand, when the total amount of the silica and bentonite is less than 0.4, the stability of the aqueous dilution of the present granular pesticidal formulation tends to decrease.

Furthermore, the weight of the bentonite (D) is 0.6 to 0.05 times of the weight of the silica (C). When the amount of the bentonite is over 0.6, the granular pesticidal formulation has poor disintegrability in water after long preservation. Moreover, when the granular pesticidal formulation include no bentonite, the granulation is difficult or the obtained granules have insufficient strength.

The surfactant (E) used for the present granular pesticidal formulation is not restricted; however, an anionic surfactant is preferably used in general. Typical examples of the surfactant include sulfate salts such as lauryl sulfate; sulfonate salts such as lignin sulfonate, condensate of naphthalene sulfonate with formalin and dodecylbenzenesulfonate; polycarboxylate salts such as sulfosuccinate and copolymer of maleic anhydride with diisobutylene; and amino acid salts such as N-acylgultamate and alkylmethyltaurine. In the present invention, a combination of two or more surfactants selected from the above-mentioned anionic surfactants is preferably used.

The amount of the surfactant (E) is 5-20%, preferably 10-20% by weight in the present granular pesticidal formulation.

The present granular pesticidal formulation optionally comprise further additives such as preservative, stabilizer, synergist, coloring agent, perfume, lubricant, antioxidant and so on.

The present granular pesticidal formulation can be produced by the conventional methods for producing granules. The liquid pesticidal component, saccharide, silica, bentonite and surfactant are mixed with ribbon mixer, Henschel mixer, Nauta mixer or the like, and then pulverized with pin mill, hammer mill, jet mill or the like. After a suitable amount of water is added thereto, the mixture is kneaded with twin-arm kneader, granulated with twin domeglan, single domeglan, basket type piston granulator, horizontal piston granulator or the like, dried and sieved to give the product. The amount of water used for kneading is usually within the range of 5-15 parts by weight based on 100 parts by weight of the pulverized product, but may be adjusted according to the hardness of the kneaded mixture including water. When an organic solvent is used for the liquid pesticidal component, a pesticidally active compound is dissolved with the organic solvent by heating, if necessary. The saccharide is preferably used in the form of powders having 20-300 μm of volume median diameter. When the piston granulator is used, it preferably has 0.5-1.5 φmm screen. The temperature for drying the granules is preferably 100° C. or less, more preferably 80° C. or less. The particle diameter of the present granular pesticidal formulation is usually 200-2000 μm, preferably 250-1500 μm.

The present granular pesticidal formulation is used for controlling pests or regulating growth of plants. When the pesticidally active compound is an insecticidal compound, they are preferably used for vegetables or fruit trees. The present granular pesticidal formulation is usually used as water dispersible granules. Namely, the present granular pesticidal formulation is diluted with water and then applied to crop, soil or the like with a sprayer or the like. The ratio of the dilution with water depends on the kind and dosage of the pesticidally active compounds and kind and situation of the objective pests, and it is usually about 10-10000 times, preferably about 50-8000 times, more preferably about 500-4000 times.

The application of the dilution of the present granular pesticidal formulation causes few stains on the fruit or vegetable surface. Examples of the fruit and vegetable include pear, apple, cherry, peach, grape, citrus, persimmon, cucumber, watermelon, melon, tomato and green pepper.

The conventional package used for wettable powders or water dispersible granules, for example, aluminum bag, paper bag, paper container, can be used for the package of the present granular pesticidal formulation. For avoiding absorption of moisture during preservation, aluminum bag, paper bag coated with aluminum inside and polymer bag are preferable. By packing the present granular pesticidal formulation into a water soluble bag, it can be possible to dilute the present granular pesticidal formulation easily and at safe. Thus, it is preferable to pack the present granular pesticidal formulation into a water soluble bag and then charge it into the above-mentioned bag.

### EXAMPLES

The present invention will be explained by production examples and test examples in detail below, but the present invention should not be limited to the examples.

### Production Example 1

A liquid pesticidal component containing a pesticidally active compound was obtained by heating 10 parts by weight of (RS)-α-cyano-3-phenoxybenzyl 2,2,3,3-tetramethylcyclopropanecarboxylate and 15 parts by weight of phenylxylylethane (commercial name: Hisol SAS-296, organic solvent produced by Nippon Petrochemicals) to about 50° C. The liquid pesticidal component was added to a mixture of 10 parts by weight of precipitated silica (commercial name: Carplex #80, non-calcined product produced by Degussa Japan), 8 parts by weight of a condensate of aromatic sodium sulfonate with formalin (commercial name: Demol SNB, produced by Kao Corporation), 6 parts by weight of sodium dodecylbenzenesulfonate, 6 parts by weight of bentonite (commercial name: Kunipia F, produced by Kunimine Industries) and 43 parts by weight of lactose, mixed by a ribbon mixer and pulverized by pin mill to give fine powders. A suitable amount of water was added to the fine powders, kneaded with twin-arm kneader and granulated with a twin domeglan (piston granulator produced by Dalton) with a screen having 0.5 mm of piston diameter. After drying at 50° C. for 20 minutes, the granules were sieved to give the present granular pesticidal formulation 1 having 300-710 μm of diameter.

### Reference Production Example 1

The same procedure as Production example 1 was performed except that 30 parts by weight of precipitated silica (commercial name: Carplex #80, non-calcined product produced by Degussa Japan) in place of 10 parts by weight and 23 parts by weight of lactose in place of 43 parts by weight were used to give Reference formulation 1.

### Reference Production Example 2

The same procedure as Production example 1 was performed except that 20 parts by weight of precipitated silica (commercial name: Carplex #80, non-calcined product produced by Degussa Japan) in place of 10 parts by weight, 10 parts by weight of bentonite (commercial name: Kunipia F, produced by Kunimine Industries) in place of 6 parts by weight and 29 parts by weight of lactose in place of 43 parts by weight were used to give Reference formulation 2.

### Reference Production Example 3

The same procedure as Production example 1 was performed except that 30 parts by weight of precipitated silica (commercial name: Carplex #80, non-calcined product produced by Degussa Japan) in place of 10 parts by weight, 10 parts by weight of bentonite (commercial name: Kunipia F, produced by Kunimine Industries) in place of 6 parts by weight and 11 parts by weight of lactose in place of 43 parts by weight were used to give Reference formulation 3.

### Test Example 1

The tests for evaluating stains on fruit surface and disintegrability described below were performed by using the present granular pesticidal formulation 1 and Reference formulations 1, 2 and 3. The results are given in Table 1.

[Test for Evaluating Stains on Fruit Surface]

A dilution was prepared by diluting each formulation with water at 500 times. A cherry was drenched in the dilution for 30 seconds and winded for one hour to be dried on its surface. After that, ten persons evaluated the degree of the stains of the cherry by the following five indices, and the average was calculated to be the degree of strains.

Evaluation

| Indices | The degree of strains |
|---|---|
| 5 | No stains found |
| 4 | A few stains found but not worried |
| 3 | Stains found slightly |
| 2 | Stains found clearly and unpleasant |
| 1 | Stains found severely |

[Test for Evaluating Disintegrability in Water]

Each formulation was preserved for one month in a thermostat of 54° C. and then provided the following procedure.

A 250 ml-volume cylinder with a stopper containing 250 ml of 3° hard water was set at 20° C. The formulation (0.5 g) was added into the cylinder, which was then turned upside down. This upside-down turning was repeated at a rate of once per two seconds. The number of the repetition of the upside-down turning was observed to complete disintegration of the formulation.

TABLE 1

| | Stains on fruit | Disintegrability in water |
|---|---|---|
| | surface (Indices) | (times) |
| Present granular | 4.8 | 13 |
| pesticidal formulation 1 | | |
| Reference formulation 1 | 2.4 | 17 |
| Reference formulation 2 | 3.0 | 41 |
| Reference formulation 3 | 2.0 | 50 |

### Production Example 2

A liquid pesticidal component containing a pesticidally active compound was obtained by heating 9.2 parts by weight of (RS)-α-cyano-3-phenoxybenzyl 2,2,3,3-tetramethylcyclopropanecarboxylate and 10 parts by weight of phenylxylylethane (commercial name: Hisol SAS-296, organic solvent produced by Nippon Petrochemicals) to about 50° C. The liquid pesticidal component was added to a mixture of 10 parts by weight of precipitated silica (commercial name: Carplex CS-7, non-calcined product produced by Degussa Japan), 8 parts by weight of sodium polycarbonate (commercial name: Geropon SC213, produced by Rhodia Nikka), 2 parts by weight of sodium dodecylbenzenesulfonate, 6 parts by weight of bentonite (commercial name: Kunipia F, produced by Kunimine Industries) and 54.8 parts by weight of lactose, mixed by a ribbon mixer and pulverized by pin mill to give fine powders. A suitable amount of water was added to the fine powders, kneaded with twin-arm kneader and granulated with a twin domeglan (piston granulator produced by Dalton) with a screen having 0.5 mm of piston diameter. After drying at 50° C. for 20 minutes, the granules were sieved to give the present granular pesticidal formulation 2 having 300-710 μm of diameter.

### Production Example 3

The same procedure as Production example 2 was performed except that one part by weight of bentonite (commercial name: Kunipia F, produced by Kunimine Industries) in place of 6 parts by weight and 59.8 parts by weight of lactose in place of 54.8 parts by weight were used to give the present granular pesticidal formulation 3.

### Reference Production Example 4

The same procedure as Production example 2 was performed except that 10 parts by weight of bentonite (commercial name: Kunipia F, produced by Kunimine Industries) in place of 6 parts by weight and 50.8 parts by weight of lactose in place of 54.8 parts by weight were used to give Reference formulation 4.

### Test Example 2

The tests for evaluating disintegrability in water were performed by using the present granular pesticidal formulations 2 and 3 and Reference formulation 4. The test methods were the same as Test example 1. The results are given in Table 2.

TABLE 2

| | Stains on fruit surface | Disintegrability in |
|---|---|---|
| | (Indices) | water (times) |
| Present granular | 4.8 | 15 |
| pesticidal formulation 2 | | |
| Present granular | 5.0 | 7 |
| pesticidal formulation 3 | | |
| Reference formulation 4 | 4.4 | 25 |

The same procedure as Production example 1 was performed except that 10.5 parts by weight of (RS)-α-cyano-3-phenoxybenzyl 2,2,3,3-tetramethylcyclopropanecarboxylate in place of 10 parts by weight, 20 parts by weight of precipitated silica (commercial name: Carplex CS-7, calcined product produced by Degussa Japan) in place of 10 parts by weight of precipitated silica (commercial name: Carplex #80, non-calcined product produced by Degussa Japan), 8 parts by weight of sodium dodecylbenzenesulfonate in place of 6 parts by weight, 2 parts by weight of bentonite (commercial name: Kunipia F, produced by Kunimine Industries) in place of 6 parts by weight and 36.5 parts by weight of lactose in place of 43 parts by weight were used to give the present granular pesticidal formulation 4.

### Reference Production Example 5

The same procedure as Production example 1 was performed except that 10.5 parts by weight of (RS)-α-cyano-3-phenoxybenzyl 2,2,3,3-tetramethylcyclopropanecarboxylate in place of 10 parts by weight, 25 parts by weight of precipitated silica (commercial name: Carplex CS-7, calcined product produced by Degussa Japan) in place of 10 parts by weight of precipitated silica (commercial name: Carplex #80, non-calcined product produced by Degussa Japan), 8 parts by weight of sodium dodecylbenzenesulfonate in place of 6 parts by weight, 4 parts by weight of bentonite (commercial name: Kunipia F, produced by Kunimine Industries) in place of 6 parts by weight and 29.5 parts by weight of lactose in place of 43 parts by weight were used to give the Reference formulation 5.

### Test Example 3

The tests for evaluating stains on fruit surface were performed by using the present granular pesticidal formulation 4 and Reference formulation 5. The test method was the same as Test example 1. The results are given in Table 3.

TABLE 3

| | Stains on fruit |
|---|---|
| | surface (Indices) |
| Present granular pesticidal formulation 4 | 4.2 |
| Reference formulation 5 | 3.0 |

The same procedure as Production example 1 was performed except that 20 parts by weight of precipitated silica (commercial name: Carplex CS-7, calcined product produced by Degussa Japan) in place of 10 parts by weight of precipitated silica (commercial name: Carplex #80, non-calcined product produced by Degussa Japan) and one part by weight of bentonite (commercial name: Kunipia F, produced by Kunimine Industries) in place of 6 parts by weight were used to give the present granular pesticidal formulation 5.

### Production Example 6

The same procedure as Production example 1 was performed except that 20 parts by weight of precipitated silica (commercial name: Carplex CS-7, calcined product produced by Degussa Japan) in place of 10 parts by weight of precipitated silica (commercial name: Carplex #80, non-calcined product produced by Degussa Japan) and 0.5 parts by weight of bentonite (commercial name: Kunipia F, produced by Kunimine Industries) and 2 parts by weight of bentonite (commercial name: Super Clay, produced by Hojun) in place of 6 parts by weight of bentonite (produced by Kunimine Industries, commercial name: Kunipia F) were used to give the present granular pesticidal formulation 6.

### Test Example 4

The tests for evaluating stains on fruit surface and suspensibility were performed by using the present granular pesticidal formulations 5 and 6. The test method for evaluating stains on fruit surface was the same as Test example 1, and the test method for evaluating suspensibility is as follows. The results are given in Table 4.

[Test for Evaluating Suspensibility]

Each formulation was preserved for one month in a thermostat of 54° C. and then provided the following procedure.

In a 250 ml-volume cylinder with a stopper containing, the formulation was diluted 500-fold with 3° hard water at 20° C., which was then turned upside down at a rate of once per two seconds with a tumbling device. After 30 turns, it was allowed to stand at 20° C. for 15 minutes. Ten milliliters of the dilution were collected from the portion of 100-150 gradurations on the cylinder with a whole pipette. The quantitative analysis of the pesticidally active compound was performed in the obtained dilution with liquid chromatography method using an internal standard, and the ratio of the pesticidally active compound in the above dilution against theoretical concentration was calculated.

TABLE 4

| | Stains on fruit surface | |
|---|---|---|
| | (Indices) | Suspensibility (times) |
| Present granular | 4.4 | 99.2 |
| pesticidal formulation 5 | | |
| Present granular | 4.2 | 99.7 |
| pesticidal formulation 6 | | |

What is claimed is:

1. A granular pesticidal formulation which comprise:
(A) 16-40% by weight of a liquid pesticidal component,
(B) 30-70% by weight of at least one saccharide,
(C) 8-20% by weight of silica,
(D) 0.5-6% by weight of bentonite and
(E) 5-20% by weight of at least one surfactant,
wherein the total weight of the component (C) and the component (D) is 0.9 to 0.4 times of the weight of the component (A) and the weight of the component
(D) is 0.6 to 0.05 times of the weight of the component (C).

2. The granular pesticidal formulation according to claim 1, wherein the liquid pesticidal component is an organic solvent containing a pyrethroid compound.

3. The granular pesticidal formulation according to claim 2, wherein the amount of the pyrethroid compound is 5-15% by weight and the amount of the organic solvent is 5-25% by weight in the granular pesticidal formulation

4. The granular pesticidal formulation according to claim 2 or 3, wherein the organic solvent is an aromatic hydrocarbon.

5. The granular pesticidal formulation according to any of claims 1-3, wherein the saccharide is lactose.

6. The granular pesticidal formulation according to any of claims 1-3, wherein the saccharide is sucrose.

7. The granular pesticidal formulation according to any of claims 1-3, wherein the silica is calcined precipitated silica.

8. The granular pesticidal formulation according to any of claims 1-3, wherein the saccharide is lactose and the silica is calcined precipitated silica.

9. The granular pesticidal formulation according to any of claims 1-3, wherein the saccharide is sucrose and the silica is calcined precipitated silica.
